(19) United States
(12) Patent Application Publication
(10) Pub. No.: US 2016/0315705 A1
(43) Pub. Date: Oct. 27, 2016

(54) NUCLEAR POWER PLANT HAVING A SIGNAL TRANSMISSION SYSTEM AND METHOD FOR TRANSMITTING A MEASURED VALUE

(71) Applicant: AREVA GMBH, ERLANGEN (DE)

(72) Inventors: SEBASTIAN LANGGUTH, FORCHHEIM (DE); IRYNA JANKE, FUERTH (DE); JUERGEN DENNERLEIN, ERLANGEN (DE)

(21) Appl. No.: 15/180,278

(22) Filed: Jun. 13, 2016

Related U.S. Application Data
(63) Continuation of application No. PCT/EP2014/077007, filed on Dec. 9, 2014.

(30) Foreign Application Priority Data
Dec. 11, 2013 (DE) 102013113828.4

(51) Int. Cl. H04B 10/25; G21C 17/00; H04B 1/00; H04J 14/08; H04B 10/50

(52) U.S. Cl. CPC H04B 10/2504; H04J 14/08; H04B 10/503; H04B 1/0007; G21C 17/002

(57) ABSTRACT

A nuclear power plant includes a containment, a region exposed to radiation in the containment and a signal transmission system. A modulator disposed inside the region exposed to radiation converts an analog measured value provided by an associated sensor into a PWM signal. A demodulator disposed outside the region exposed to radiation reconstructs the measured value from the PWM signal. The modulator is implemented by using radiation-hardened, preferably analog, circuit technology and includes adaptable measured value normalization, a sawtooth generator and a comparator. A signal transmission line being DC-isolated from an output of the comparator connects the demodulator to the modulator. A method for transmitting a measured value from a region exposed to radiation in a containment of a nuclear power plant to an external evaluation system is also provided.

### CROSS-REFERENCE TO RELATED APPLICATION

This is a continuation application, under 35 U.S.C. §120, of copending International Application PCT/EP2014/077007, filed Dec. 9, 2014, which designated the United States; this application also claims the priority, under 35 U.S.C. §119, of German Patent Application DE 10 2013 113 828.4, filed Dec. 11, 2013; the prior applications are herewith incorporated by reference in their entirety.

### BACKGROUND OF THE INVENTION

### Field of the Invention

In the narrower sense, the invention relates to a transmission system for a nuclear installation, in particular a nuclear power plant, in which a measured value is recorded inside a containment under potentially adverse conditions with a comparatively high radiation load with the aid of at least one sensor and is transmitted to an evaluation unit positioned at some distance outside the containment over a data transmission line which is routed out of the containment. In a further sense, the circuit can also be used in other industrial sectors (and research facilities) and fields in which reliable signal transmission with a high bandwidth from a first installation region, which may be exposed to high ionizing radiation in particular, to a spatially separate installation region with a lower radiation load is required.

### SUMMARY OF THE INVENTION

It is accordingly an object of the invention to provide a nuclear power plant having a signal transmission system and a method for transmitting a measured value, which overcome the hereinafore-mentioned disadvantages of the heretofore-known devices and methods of this general type and which enable interference-free and broadband transmission of measurement signals over a longer distance under those conditions using measures which are as simple as possible.

With the foregoing and other objects in view there is provided, in accordance with the invention, a nuclear power plant including a containment, a region exposed to radiation in the containment and a signal transmission system. A modulator disposed inside the region exposed to radiation converts an analog measured value provided by an associated sensor into a PWM signal. A demodulator disposed outside the region exposed to radiation reconstructs the measured value from the PWM signal. The modulator is implemented by using radiation-hardened, preferably analog, circuit technology and includes adaptable measured value normalization, a sawtooth generator and a comparator. A signal transmission line being DC-isolated from an output of the comparator connects the demodulator to the modulator.

With the objects of the invention in view, there is also provided a method for transmitting a measured value from a region exposed to radiation in a containment of a nuclear power plant to an external evaluation system. According to the method, a physical variable which is recorded by a sensor and is converted into an analog electrical measured value is converted into a PWM signal inside the region exposed to radiation in a modulator having analog circuit technology by comparison with a sawtooth oscillation. After DC-decoupling from the measurement input of the modulator, the PWM signal is transmitted from the region exposed to radiation to a demodulator disposed outside over a signal transmission line. The measured value is reconstructed from the received PWM signal in the demodulator and is supplied to the evaluation system.

Put simply, an isolating amplifier with DC-isolation of the sensor input signals from the output signals transmitted through the data transmission line is provided and is based on the fundamental principle of pulse width modulation, in which case the modulator required for this purpose is disposed on the input side of the transmission path formed by the data transmission line inside the containment and the demodulator is disposed on the output side of the transmission path outside the containment. However, the demodulator may also be disposed inside the containment, for example in an annular space which is shielded from radiation. The aim is, in particular, to transmit the signal from a region with high ionizing radiation to a region with lower ionizing radiation or without ionizing radiation in an interference-free manner. Highly insulating DC-isolated transmission of an analog signal with a high bandwidth, for direct analog/digital conversion with a high resolution, from an installation region which is radiologically loaded in malfunction situations to a safe installation region is carried out.

That is to say, in other words, the measurement variable is converted into a signal with two binary states by using the analog comparison of a constantly increasing comparison voltage with a conditioned measured value. The value or the amplitude of the measurement variable is reproduced in the temporal behavior of the binary signal resulting in this manner. After DC-isolation, a signal which can be transmitted over large distances in serial form with a high temporal resolution is therefore available.

In the preferred use in the nuclear environment, signal lines and therefore also containment bushings can be saved in the case of suitable transmission protocols (for example multiplexing or modulation methods such as time division multiplexing methods or amplitude and frequency modulation).

The advantages which are achieved with the invention can be characterized as follows, in particular:

### 1. Radiation-Hard Embodiment

In contrast to commercial isolating amplifiers from different manufacturers which are available on the market, the digital isolating amplifier implemented inside the transmission system according to the invention is optimized for increased reliability with respect to ionizing radiation.

Radiation hardening is based on the following three fundamental principles which are preferably used cumulatively:
The operating points of the electronic circuits exposed to radiation are optimized or adapted for an increased service life under a radiation load. For this purpose, it is possible to resort, inter alia, to proven concepts and standards from reliability analysis or technology. Specific component parameters which enable such influence are, for example, the operating temperature of the circuit, the supply voltage, the input voltage, the output voltage, the output current intensity and the mechanical stress profile. This type of radiation hardening is also referred to as “hardening by circuit design.”
The damaging influence of a shift of operating points, which is caused or rendered necessary by radiation, at the transistor level can be minimized by suitably (remotely) controlling the operating state. In this case, compensation effects based on physical effects are activated at the system level. Specific measures in this context include, for example, switching the voltage supply on and off, increasing or reducing the operating voltage, inverting/reversing the polarity of the operating voltage and/or increasing or reducing the operating temperature. This type of radiation hardening is also referred to as “hardening by system design.”
Radiation hardening can also be carried out by selecting a suitable manufacturing technology. Semiconductors having comparatively wide band gaps, for example SiGe, GaAs, InPh, SiC, are inherently resistant to radiation due to the high activation energies needed to destroy their atomic lattices. A similar situation applies to semiconductor manufacturing processes with structure sizes in the range of 60 to 150 nm. This type of radiation hardening is also referred to as “hardening by technology.”
   2. Measurement Input which can be Changed Over

In contrast to known isolating amplifiers which have only a limited number of input signals which can be changed over, a much greater number of analog interfaces is possible as a result of a normalizing amplifier which can be plugged onto the system circuit board of the modulator. In addition to the typical single-ended voltage and current inputs, it is hereby possible to implement both single-ended and differential-ended inputs for charge, resistance, frequency, etc. It is likewise possible to use input ranges outside the typical interface values.

3. Spatial Separation between the Modulator and the Demodulator

Isolating amplifiers on the market are usually optimized for space saving. The modulator and the demodulator for the DC-isolating transmission path are in one housing. As a result of the spatial separation of the modulator side and the demodulator side in the system according to the invention, it is possible to convert an analog signal in an environment with high electromagnetic interference with the aid of analog components and to transmit this signal over large distances of up to several hundred meters, for example, in an extremely interference-free form in an amplitude-digital manner and with analog time coding (pulse width modulation, PWM for short).

### 4. Direct A/D Conversion Possible

As a result of the amplitude-digital (that is to say only two logical states of the amplitude are possible) output at the modulator, it is possible to directly convert the value of the amplitude of the normalized measured value (K) into a digital form by using precise time measurement (for example counting methods) of the pulse duration of the PWM signal in relation to the period duration of the sawtooth oscillation. In the conventional isolating amplifiers, it is necessary to digitize the analog output signals again by using analog/digital converters (ADC). The direct ND conversion results in a converter which is optimized with respect to the effect of ionizing radiation.

### 5. Synchronous Sampling of a Plurality of Isolating Amplifiers

The synchronous triggering of a plurality of modulator stages makes it possible to eliminate component tolerances which affect the time base. With the direct conversion into digital data (see point 4), it is hereby possible to implement locating functions by using triangulation. In conventional analog/digital converters, synchronous sampling is generally possible only through diversions.

### 6. Signal Multiplexing Possible

As a result of the amplitude-digital transmission between the modulator and the demodulator over a large distance, it is possible to use simple circuit technology to transmit a plurality of channels over a single connecting line (for example through amplitude modulation, frequency modulation, time division multiplexing methods). This is fundamentally likewise possible in the case of analog signals, but greater losses in the performance and bandwidth result in that case. The analog circuit technology required for this purpose is not only more complex and cost-intensive but also more susceptible to faults. Modulation onto existing lines (for example existing power lines, AC or DC) is very easily possible using the amplitude-digital signals from the digital isolating amplifier according to the invention and is possible using a greater bandwidth than with analog signals.

Other features which are considered as characteristic for the invention are set forth in the appended claims.

Although the invention is illustrated and described herein as embodied in a nuclear power plant having a signal transmission system and a method for transmitting a measured value, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a block diagram of a transmission system for a nuclear power plant, in which interference-free and broadband transmission of measurement signals is carried out over a large distance with the aid of a digital isolating amplifier;

FIG. 2 is a diagrammatic illustration of the level behavior over time of different signals which occur and are processed in the isolating amplifier according to FIG. 1; and

FIG. 3 is a block diagram of a modification of the transmission system according to FIG. 1.

### DETAILED DESCRIPTION OF THE INVENTION

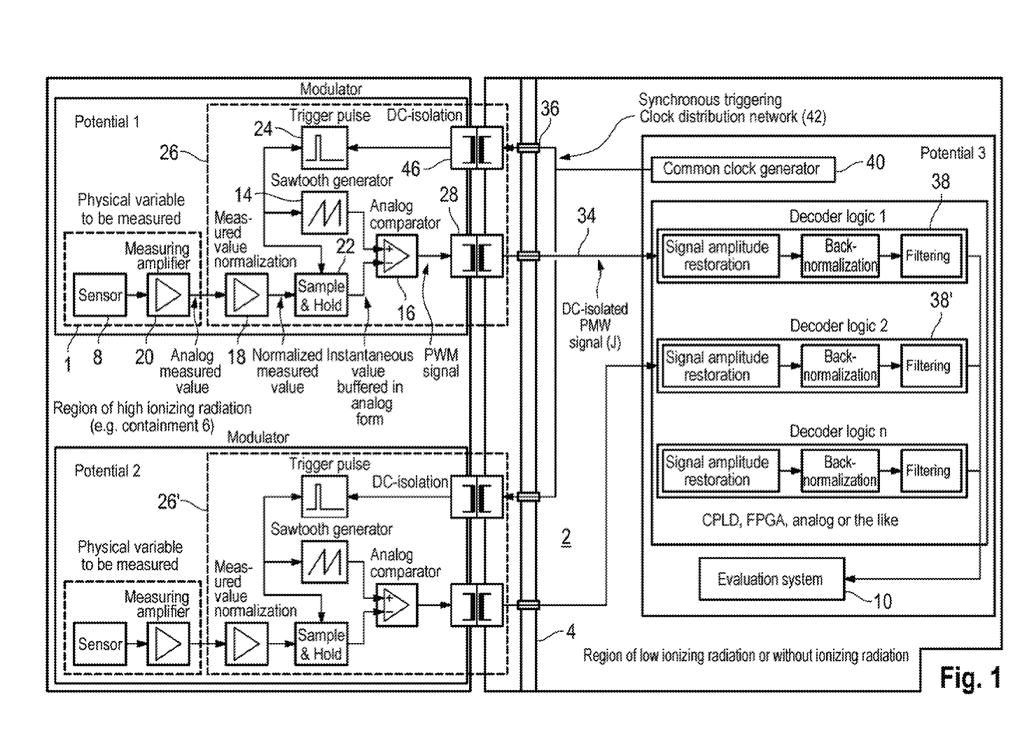

Referring now in detail to the figures of the drawings, in which identical or identically acting components or signals are provided with the same reference symbols, and first, particularly, to FIG. 1 thereof, there is seen a section of a nuclear power plant 2 in which a steel and/or concrete containment shell 4 surrounds a space in which intensive release of ionizing radiation can occur in the event of malfunctions. In order to monitor relevant operating and state parameters inside a containment 6, at least one malfunction-proof sensor 8 is installed therein and transmits measurement data to an external evaluation system 10 through an interposed transmission system.

The sensor 8 records a physical variable (for example pressure, temperature, radiation, etc.) which is provided as an electrical signal in the form of an analog measured value K.

The measured values to be transmitted are therefore recorded and preprocessed by sensors inside the containment 6 in a measured value recording and transmitting module which is indicated herein by a rectangular box and is at an electrical potential 1.

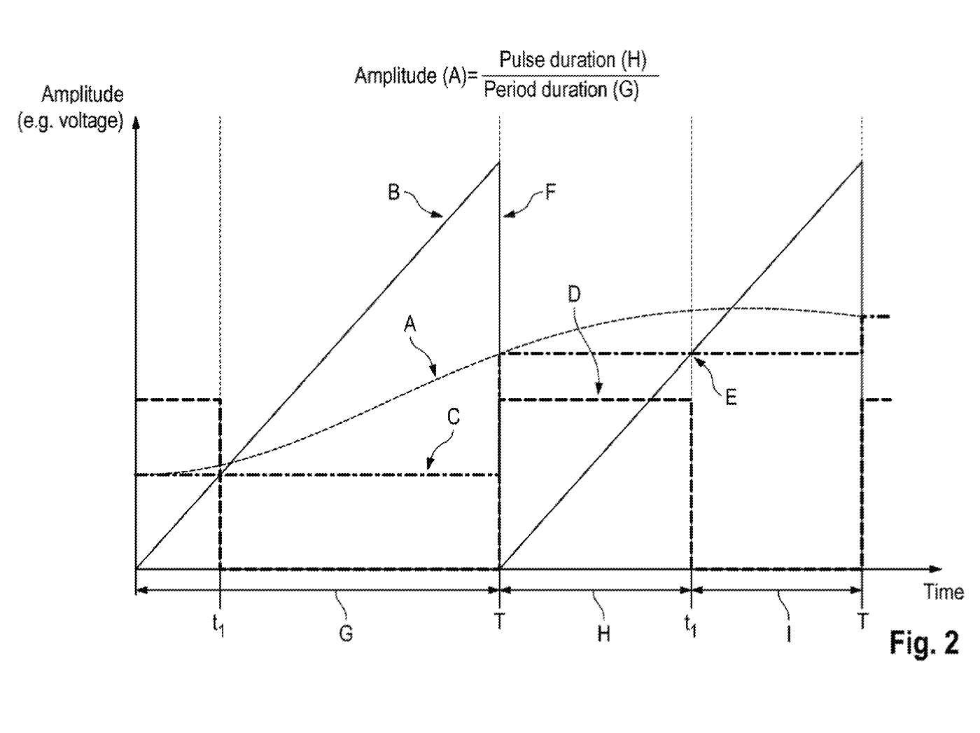

A capacitance charged through a constant current source is used to generate a temporally linearly increasing voltage in a sawtooth generator 14, which is suddenly reset to 0 V after a period duration T. The profile of this sawtooth oscillation B as a function of time is diagrammatically illustrated in FIG. 2 in addition to other signal levels which are described further below.

This sawtooth voltage which runs periodically and increases in sections is compared with an instantaneous measurement variable, which was previously converted to a voltage signal and was normalized to the maximum end value of the generated sawtooth voltage after reaching the duration T, in an analog manner with high accuracy by using a comparator 16.

The analog measured value K is normalized by using a normalizing amplifier 18 which also converts the output variable of a measuring amplifier 20 needed for the sensor 8 (voltage, current, charge, frequency, resistance value; single-ended or differential) to the electrical variable needed for the comparator 16.

The circuit needed to normalize the measured value is preferably in the form of a subassembly which is (ex)changeable and lockable, in particular pluggable, and has a permanently defined size and connection assignment in order to be able to cover a great flexibility of input signals.

A sample and hold circuit 22 is used to buffer the normalized analog measured value A pending at the start of the measurement cycle for the measurement duration T in an analog form (stored instantaneous value C) in order to minimize errors caused by rapidly changing signals. The sample and hold circuit 22 is triggered by a pulse generator 24 which also triggers the sawtooth generator 14. The pulse generator 24 is in turn triggered/synchronized by an external clock generator 40 (see below).

As soon as the level of the generated sawtooth oscillation B reaches or just (minimally) exceeds the level of the applied, normalized and buffered comparison voltage C after the time t₁ (comparison time E), the output of the comparator 16 changes the output level from a logical level to the non-equivalent logical level.

This generates a binary output signal D which is in the form of a pulse-width-modulated signal (PWM signal). The components responsible for modulation, the sample and hold circuit 22, the sawtooth generator 14 and the associated pulse generator 24 as well as the analog comparator 16, are also referred to in their entirety as a modulator 26 and are part of a transmitting module of the transmission circuit.

The amplitude-binary output signal D at the comparator output is isolated from the potential of the measurement variable in a highly insulating manner by using DC-isolation 28 through suitable coupling (for example optical, capacitive or transforming signal transformers). The DC-isolation 28 is preferably durable up to several kV depending on the specific embodiment of the signal separation and the safe isolation of the supply voltage.

This DC-isolated PWM signal J is transmitted in an interference-free manner in a suitable form—for example in the form of a differential voltage signal, through a current loop, in frequency-modulated (FM) form, in amplitude-modulated (AM) form, through phase modulation (PSK)—over a comparatively long transmission path of up to several hundred meters to decoder logic disposed outside the containment 6 in the region of low ionizing radiation in a receiving and evaluation module having an electrical potential 3. A signal transmission line 34 runs in a suitable manner through a bushing 36 in the containment shell 4. In order to maximize the signal-to-noise ratio and to minimize electromagnetic interference, transmission in the form of a pair of differential signals is preferred.

In order to provide a transmission which is as loss-free and uncorrupted as possible, it is necessary to match the output impedance of the transmitting amplifier on the modulator side to the characteristic impedance of the signal transmission line 34 being used and to the input impedance of the decoder logic.

As already mentioned, after DC-isolation, the PWM signal D can be transmitted as a voltage signal, a current intensity signal or an optical signal. In the two cases mentioned first, the respective signal transmission line 34 can be implemented with the aid of copper cables, for example. In contrast, optical signals are preferably transmitted with the aid of polymer fiber cables or fiber-optic cables, in which case quartz glass fibers generally have a greater resistance to radiation and are therefore preferred in the application presented in this case. Depending on the selected type of signal transmission, it is necessary, under certain circumstances, to modify the respective modulator 26 or to supplement it, in terms of circuitry, with the functions required for a media converter. Media converters are devices which are used in the field of networks and connect network segments of different media (for example copper, optical waveguide) to one another and therefore physically convert the transmitted data from one medium to the other. If a multiplexer 47 (see below) is used, the media converter can also be integrated in the multiplexer.

In a preferred configuration, optical signal transmission takes place, in which case the media converter required for this purpose is preferably implemented with the aid of laser diodes on the transmitter side. Laser diodes can be considered to be operationally proven and have a comparatively high resistance to radiation. Suitable fiber-optic transmission cables which are suitable for use in environments with a high radiation load (gamma and neutron radiation) have also existed for a few years. Due to the pulsed transmission, even a high degree of damage to the laser diodes, caused by radiation, with a correspondingly reduced light yield or luminosity can be dealt with, with the result that the effectively usable service life of the signal transmission system is considerably increased in comparison with other technologies. Another advantage of optical signal transmission is the high degree of DC-isolation and the insensitivity to electromagnetic interference (EMI). Optical transmission cables also prevent the potential of different grounding points being transferred inside the power plant.

Inside the decoder logic, the amplitude value which is normalized and the time behavior of which is coded is restored, and normalization back to an output value proportional to the original physical measured value is carried out for further evaluation and is possibly filtered. The components responsible for this are also referred to in combination as the demodulator 38.

The decoding can be carried out in an analog manner and can output the reconstructed analog measured value to the evaluation system 10.

Another possibility for reconstruction resides in the direct, high-resolution time measurement of the pulse duration of the PWM signal J by a digital module (for example CPLD; FPGA; DSP; ASIC; digital measuring card; etc.), which, in direct connection with the constant period duration T of the sawtooth oscillation B, constitutes a proportionality to the normalized measured value A and can likewise be normalized back and filtered.

If this digital value formation is also carried out inside the containment 6, preferably in a region with relatively low ionizing radiation, a large number of signals can be transferred to an external evaluation signal using few bushings by using a digital bus and a multiplexing method.

The sampling frequency according to the Nyquist-Shannon sampling theorem, which is needed to reconstruct sinusoidal signals without losses, is more than twice the maximum frequency of the measurement variable. Increasing the sampling frequency further (oversampling) makes it possible to minimize (analog) or remove (digital) interference signals above the target sampling frequency which occur during subsequent analog or digital filtering. Therefore, the frequency (reciprocal of the period duration T) of the sawtooth oscillation B should be above four times (preferably in powers of two) the analog cut-off frequency of the normalizing amplifier.

Temporally synchronous conversion of a plurality of different measured values from different measuring points, as is required for locating functions according to the triangulation principle, can be implemented by using a synchronous trigger pulse from the common clock generator 40, which pulse is supplied in an isolated manner for the start of a sawtooth oscillation to any desired number (depending on the driver stage and pulse distortion) of conversion circuits. The common clock signal is preferably distributed to the individual subassemblies in this case through a so-called clock distribution network which is executed in a tree structure (clock tree).

FIG. 1 illustrates, by way of example, the case of two measured value recording and transmitting modules which have a functionally similar structure and one of which is at a first electrical potential with respect to the physical variable to be measured by it and the other of which is at a second electrical potential which is generally different therefrom. Each of the two modules transmits a PWM-coded measurement signal, over its own transmission path (transmission line 34) which is assigned to it and is DC-isolated from the measurement input and from the supply voltage, to its own decoder logic which is assigned to it and in which back-normalization and filtering are respectively carried out in addition to restoring the signal amplitude. The decoder circuits are connected, on the output side, to the input of the common evaluation system 10. It goes without saying that generalization to n=3, 4, . . . measurement signals is possible. The identical subsystems and their respective components are distinguished in this case from one another by lines on the reference symbols, for instance 8, 8′, 8″.

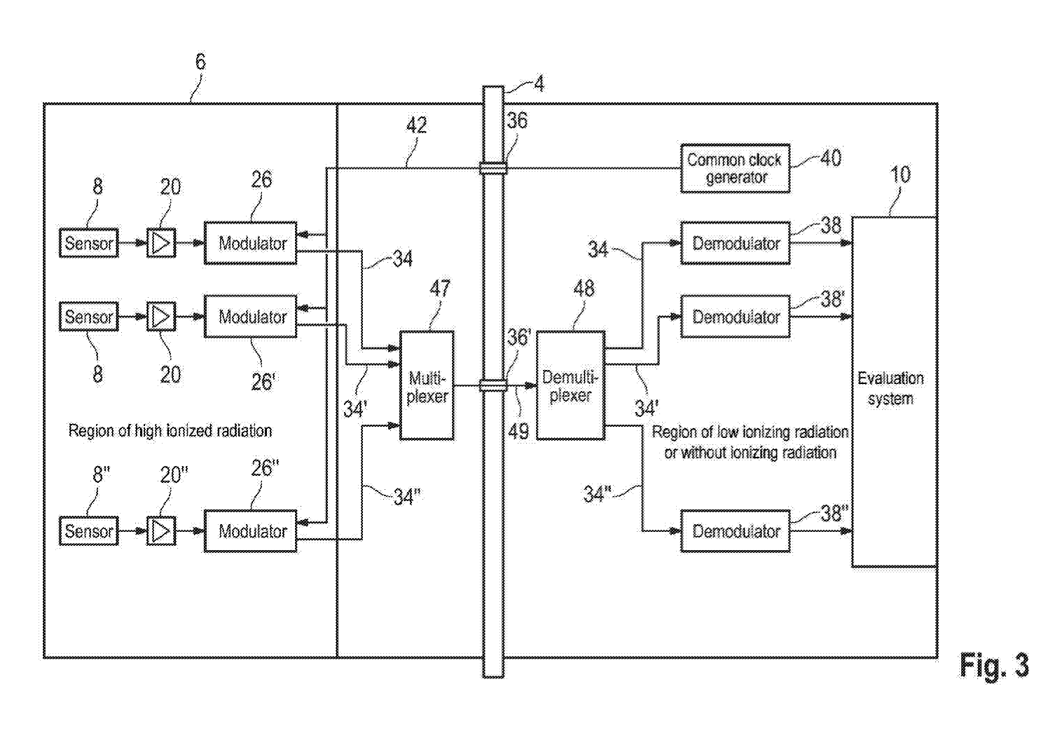

Instead of separate transmission paths, multiple use of a single signal transmission line 49 according to the principle of the serial interface can be provided, as described above, using an interposed multiplexer 47 on the input side of the transmission path and possibly a demultiplexer 48 (which can alternatively also be integrated in the evaluation system 10) on the output side. A system modified in this manner is schematically illustrated in FIG. 3.

The common clock generator 40 disposed outside the containment 6 simultaneously controls the pulse generators 24 of the individual measured value recording and transmitting modules through a clock line 42 which branches into individual strands in the form of a tree (possibly through suitable electronic signal distributors with a small phase angle deviation [jitter], also cascaded). The clock line(s) 42 is/are connected to these modules with DC-isolation in a similar manner to that during measurement signal output through corresponding optical, capacitive or transforming (inductive) signal transformers (DC-isolation 46, also see FIG. 1).

The particular demands imposed on the semiconductor components with respect to an environment with ionizing radiation require a firm selection of manufacturing technologies—for example based on gallium arsenide (GaAs), gallium nitride (GaN), silicon carbide (SiC)—which are suitable for reliable operation under such conditions. This applies, in particular, to all components which are situated inside the containment 6 in regions with an increased load during normal operation, but also in the event of a malfunction, caused by ionizing radiation.

The following is a summary list of reference numerals and the corresponding structure used in the above description of the invention:
2 Nuclear power plant
4 Containment shell
6 Containment
8 Sensor
10 Evaluation system
14 Sawtooth generator
16 Comparator
18 Normalizing amplifier
20 Measuring amplifier
22 Sample and hold circuit
24 Pulse generator
26 Modulator
28 DC-isolation
34 Signal transmission line
36 Bushing
38 Demodulator
40 Common clock generator
42 Clock line
46 DC-isolation
47 Multiplexer
48 Demultiplexer
49 Common signal transmission line
A Analog measured value (normalized)
B Sawtooth oscillation
C Instantaneous value of A stored in analog form
D Digital PWM output signal
E Comparison time
F Return of the sawtooth oscillation
G Period duration of the sawtooth oscillation
H Pulse duration of the PWM signal
I Pause duration of the PWM signal
J DC-isolated PWM signal
K Analog measured value (non-normalized)

1. In a nuclear power plant including a containment, a region exposed to radiation in the containment and a signal transmission system, the improvement comprising:
a sensor disposed inside the region exposed to radiation for providing an analog measured value;
a modulator disposed inside the region exposed to radiation for converting the analog measured value into a PWM signal; and
a demodulator disposed outside the region exposed to radiation for reconstructing the measured value from the PWM signal;
said modulator being implemented by using radiation-hardened circuit technology and including adaptable measured value normalization, a sawtooth generator and a comparator having an output; and
a signal transmission line being DC-isolated from said output of said comparator, said signal transmission line connecting said demodulator to said modulator.

2. The nuclear power plant according to claim 1, wherein said circuit technology is analog circuit technology.

3. The nuclear power plant according to claim 2, which further comprises an analog/digital converter connected upstream of said signal transmission line and based on precise time measurement of a pulse duration in relation to a period duration for converting the analog time-coded PWM signal into a digital value.

4. The nuclear power plant according to claim 3, wherein said an analog/digital converter uses counting methods.

5. The nuclear power plant according to claim 1, which further comprises a clock generator, said modulator being one of a plurality of modulators, said demodulator being one of a plurality of demodulators, and said plurality of modulators and demodulators interacting and being simultaneously triggered in common by said clock generator.

6. The nuclear power plant according to claim 5, which further comprises a signal transmission line, and a multiplexer for transmitting a plurality of DC-isolated PWM signals in common over said signal transmission line.

7. The nuclear power plant according to claim 1, wherein said signal transmission line is an optical waveguide for optical signal transmission.

8. The nuclear power plant according to claim 7, wherein said optical waveguide has quartz glass fibers.

9. The nuclear power plant according to claim 7, which further comprises a media converter having a plurality of laser diodes.

10. A method for transmitting a measured value from a region exposed to radiation in a containment of a nuclear power plant to an external evaluation system, the method comprising the following steps:
using a sensor to record a physical variable;
converting the physical variable into an analog electrical measured value;
converting the analog electrical measured value into a PWM signal inside the region exposed to radiation in a modulator having analog circuit technology, by comparison with a sawtooth oscillation;
DC-decoupling the PWM signal from a measurement input of the modulator;
subsequently transmitting the PWM signal over a signal transmission line from the region exposed to radiation to a demodulator disposed outside the region exposed to radiation; and
reconstructing the measured value from the received PWM signal in the demodulator and supplying the measured value to the external evaluation system.

11. The method according to claim 10, which further comprises transmitting a plurality of PWM signals over a common signal transmission line in a multiplexing method.

12. The method according to claim 11, wherein the multiplexing method is a time division multiplexing method.
